(19) United States
(12) Patent Application Publication
(10) Pub. No.: US 2026/0329394 A1
(43) Pub. Date: Oct. 22, 2026

(54) INFORMATION PROCESSING SYSTEM AND CONTROL METHOD

(71) Applicant: Lenovo (Singapore) Pte. Ltd., Singapore (SG)

(72) Inventors: Keiichi Yoshitomi, Kanagawa (JP); Mitsuhiro Yamazaki, Kanagawa (JP)

(73) Assignee: Lenovo (Singapore) Pte. Ltd., Singapore (SG)

(21) Appl. No.: 19/288,456

(22) Filed: Aug. 1, 2025

(30) Foreign Application Priority Data
Aug. 5, 2024 (JP) 2024-128849

(51) Int. Cl. G06F 3/038; G06F 3/01; G06F 3/0354

(52) U.S. Cl. CPC G06F 3/0383; G06F 3/016; G06F 3/03545

(57) ABSTRACT

An information processing system includes an information processing apparatus and a pen capable of communicating with the information processing apparatus. The pen includes a vibration generator that vibrates based on a waveform signal, an output unit that samples the waveform signal containing a first frequency component as a sound signal and a second frequency component as a vibration signal and outputs the waveform signal to the vibration generator, and a control unit that, when sampling the waveform signal, changes a sampling rate of the waveform signal in accordance with the movement speed of the pen while moving in contact with an operation symmetrical surface. The second frequency component as the vibration signal is set to have a bandwidth corresponding to the change in the frequency of the waveform signal when the sampling rate is changed relative to a preset frequency of the vibration generator.

### CROSS-REFERENCE TO RELATED APPLICATIONS

This application claims priority to Japanese Patent Application No. 2024-128849 filed on Aug. 5, 2024, the contents of which are hereby incorporated herein by reference in their entirety.

### TECHNICAL FIELD

Embodiments of the present invention relate to an information processing system and to a control method. Background

In recent years, there has been known an information processing system including a pen, which is an input device also known as an electronic pen, smart pen, or stylus, and an information processing apparatus such as a tablet device capable of handwritten input using the pen (refer to, for example, PCT Japanese Translation Patent Publication No. 2017-537395). In this kind of information processing system, the pen may be equipped with an actuator that generates vibrations, for example, and attempts have been made to reproduce the tactile sensation of actually writing on paper using this kind of pen by generating vibrations while using the pen.

In addition to generating vibrations, attempts have also been made to reproduce writing sounds by generating sounds during handwritten input using the aforementioned pen. In such cases, incorporating a speaker in addition to an actuator in the pen increases costs. Therefore, it has been considered to utilize the sounds generated by the vibrations of the actuator to generate both vibrations and sounds using only the actuator, without incorporating a speaker. For example, by providing a waveform signal containing both a frequency component signal for generating vibrations and a frequency component signal for generating sounds to the actuator according to the pressure and speed of the pen, it is possible to create a tactile sensation similar to writing with a pen, along with the sound of writing.

Furthermore, in order to convey nuances of handwritten input by a pen more effectively through sound, it would be desirable if the volume could be varied according to the pressure and speed of the pen, or if the pitch (the highness or lowness of a tone) could be varied according to the speed of the pen. There has been, however, a problem that attempting to vary the pitch by modulating the frequency of the waveform signal sent to the actuator through sampling rate changes causes the frequency components necessary for generating vibration to shift, thereby affecting the vibration level.

### SUMMARY

Embodiments of the present invention provide an information processing system and a control method capable of conveying nuances of handwritten input by a pen more effectively.

An information processing system according to the first aspect of the present invention includes: an information processing apparatus; and a pen configured to communicate with the information processing apparatus, wherein the pen includes: a vibration generator that vibrates based on a waveform signal; an output unit that samples the waveform signal containing a first frequency component as a sound signal and a second frequency component as a vibration signal and outputs the waveform signal to the vibration generator; and a control unit that changes a sampling rate when performing the sampling in accordance with the movement speed of the pen that moves in contact with an operation symmetrical surface; wherein the second frequency component as the vibration signal is set to have a bandwidth corresponding to the change in the frequency of the waveform signal when the sampling rate is changed relative to a preset frequency of the vibration generator.

In the above information processing system, the vibration generator may be a linear resonant actuator, and the preset frequency of the vibration generator may be a resonant frequency of the vibration generator.

In the above information processing system, in the waveform signal, the first frequency component as the sound signal may be set to a bandwidth different from the bandwidth of the second frequency component as the vibration signal, the vibration generator may generate sound based on the first frequency component as the sound signal contained in the waveform signal output from the output unit, and the pitch of the generated sound may change in accordance with changes in the sampling rate.

In the above information processing system, the information processing apparatus may include: a speed detection unit that detects the movement speed of the pen that moves in contact with the operation symmetrical surface; and a transmission unit that transmits information about the movement speed of the pen detected by the speed detection unit to the pen, and the pen may include a receiving unit that receives information about the movement speed of the pen transmitted from the information processing apparatus, and the control unit may change the sampling rate used for performing the sampling in accordance with the movement speed of the pen, based on the information about the movement speed of the pen received by the receiving unit.

In the above information processing system, the pen may include an amplifier that amplifies the waveform signal output from the output unit and outputs the waveform signal to the vibration generator, and the control unit may control the amplification rate of the amplifier according to the movement speed of the pen.

In the above information processing system, the information processing apparatus may include a display unit as the operation symmetrical surface.

A control method according to the second aspect of the present invention, for an information processing system that includes an information processing apparatus and a pen configured to communicate with the information processing apparatus and having a vibration generator that vibrates based on a waveform signal, includes the steps of: sampling the waveform signal containing a first frequency component as a sound signal and a second frequency component as a vibration signal and outputting the waveform signal to the vibration generator, with the pen; and changing a sampling rate when performing the sampling in accordance with the movement speed of the pen that moves in contact with an operation symmetrical surface, with the pen, wherein the second frequency component as the vibration signal is set to have a bandwidth corresponding to the change in the frequency of the waveform signal when the sampling rate is changed relative to a preset frequency of the vibration generator.

Embodiments of the present invention can convey nuances of handwritten input by a pen more effectively.

### BRIEF DESCRIPTION OF THE DRAWINGS

FIG. 1 is an exterior view illustrating an example of an information processing system according to one or more embodiments.

FIG. 2 is a diagram illustrating an example of a main hardware configuration of the information processing system according to one or more embodiments.

FIG. 3 is a block diagram illustrating an example of a functional configuration of the information processing system according to one or more embodiments.

FIGS. 4A-4B are diagrams illustrating an example of the frequency characteristics of a conventional waveform signal.

FIG. 5 is a diagram illustrating an example of the frequency characteristics of a waveform signal according to one or more embodiments.

FIG. 6 is a flowchart illustrating an example of pitch change processing of sound generated by a pen in the information processing system according to one or more embodiments.

### DETAILED DESCRIPTION

The following describes an information processing system and a control method according to one or more embodiments of the present invention, with reference to accompanying drawings.

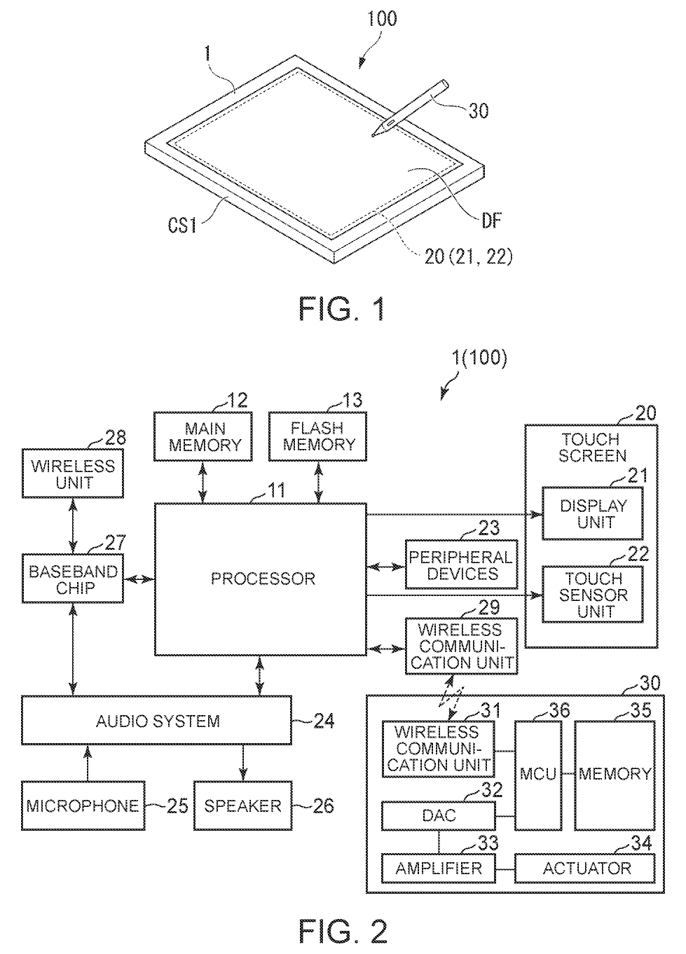

FIG. 1 is an exterior view illustrating an example of an information processing system 100 according to one or more embodiments.

As illustrated in FIG. 1, the information processing system 100 includes a tablet device 1 and a pen 30. In one or more embodiments, the tablet device 1 is described as an example of an information processing apparatus.

The tablet device 1 has a touch screen 20 installed on one of the main surfaces of the chassis CS1, and is used to execute application programs such as, for example, a notepad or drawing program with the pen 30.

The touch screen 20 includes a display unit 21 and a touch sensor unit 22, and the display unit 21 displays various information on a display screen DF. Subsequently, the main hardware configuration of the information processing system 100 is described with reference to FIG. 2.

The touch sensor unit 22 is stacked on top of the display unit 21 and detects when the pen 30 comes into contact with the display screen DF of the display unit 21, as well as detecting the contact position of the pen 30. The 339001 details of the touch screen 20, the display unit 21, and the touch sensor unit 22 are described later.

FIG. 2 is a diagram illustrating an example of the main hardware configuration of the information processing system 100 according to one or more embodiments.

As illustrated in FIG. 2, the information processing system 100 includes the tablet device 1 and the pen 30. The tablet device 1 includes a processor 11, a main memory 12, a flash memory 13, a touch screen 20, peripheral devices 23, an audio system 24, a microphone 25, a speaker 26, a baseband chip 27, a wireless unit 28, and a wireless communication unit 29.

The processor 11 is an application processor that includes, for example, a central processing unit (CPU). The processor 11 controls the entire tablet device 1.

The main memory 12 is a writable memory used as a read-in area for an execution program of the processor 11 or as a work area for writing processing data of the execution program. The main memory 12 is, for example, composed of multiple dynamic random access memory (DRAM) chips. The execution program includes an operating system (OS), various device drivers for operating peripheral equipment using hardware, various services/utilities, application programs (application software), and the like.

The flash memory 13 is, for example, a flash electrically erasable programmable read-only memory (EEPROM), and stores the OS, various drivers, various services/utilities, application programs (hereinafter, referred to as "applications" in some cases), and various data.

The display unit 21 is, for example, a liquid crystal display (LCD) or an organic electro-luminescence (EL) display, and displays a display screen based on drawing data (display data) output from the processor 11. The display unit 21 is capable of displaying the movement trajectory (drawing trajectory) of the pen 30.

The touch sensor unit 22 detects the position of an operation medium such as the pen 30 on the screen (display screen DF) of the display unit 21 and the contact of the pen 30 with the screen. The touch sensor unit 22 detects the contact position of the pen 30 on the screen of the display unit 21.

The peripheral devices 23 include, for example, a wireless local area network (WLAN) module, a global positioning system (GPS) module, and sensors such as an acceleration sensor.

The audio system 24 is, for example, an audio integrated circuit (IC), which performs input, recording, playback, and output of audio data. The audio system 24 is connected to, for example, a microphone 25 and a speaker 26. The audio system 24 outputs the audio data picked up by the microphone 25 to the processor 11 or the baseband chip 27. Additionally, the audio system 24 converts audio data acquired from the processor 11 or the baseband chip 27 into a sound signal and outputs the sound signal to the speaker 26.

The microphone 25 picks up sounds around the tablet device 1. For example, the microphone 25 picks up the user's voice, voices of people in the vicinity, music or voice output from speakers installed in the vicinity, and ambient sounds in the vicinity.

The speaker 26 outputs various sounds to the outside of the tablet device 1. For example, the speaker 26 outputs (plays) music or voice played on the tablet device 1, voice received from other devices, or music or voice delivered from servers or other sources and received.

The baseband chip 27 is a dedicated IC that controls wireless communication such as, for example, 4G (fourth- generation mobile communication system) or 5G (fifth- generation mobile communication system). The baseband chip 27 outputs voice data received via the wireless unit 28 to the speaker 26 through the audio system 24. Additionally, the

baseband chip 27 acquires audio data picked up by the microphone 25 through the audio system 24 and outputs the audio data via the wireless unit 28 using the mobile communication system. Furthermore, the baseband chip 27 performs data communication with the processor 11 for input/output data of data communication by the mobile communication system.

The wireless unit 28 is a wireless communication device including an antenna for performing wireless communication by the mobile communication system.

The wireless communication unit 29 is, for example, a Bluetooth (registered trademark) module, and performs wireless communication with the pen 30. For example, the wireless communication unit 29 transmits pen position information indicating the contact position of the pen 30 on the screen of the display unit 21, pen speed information indicating the movement speed of the pen 30 that moves in contact with the screen, and so on to the pen 30.

The pen 30 is an operation medium in the shape of a pen, such as, for example, a touch pen or a stylus pen. The pen 30 is capable of communicating with the tablet device 1 via wireless communication, such as, for example, Bluetooth (registered trademark). The pen 30 includes a wireless communication unit 31, a digital analog converter (DAC) 32, an amplifier 33, an actuator 34, a memory 35, and a micro controller unit (MCU) 36.

The wireless communication unit 31 is, for example, a Bluetooth (registered trademark) module, and performs wireless communication between the tablet device 1 and the pen 30. For example, the wireless communication unit 31 receives, for example, pen position information and pen speed information of the pen 30 from the tablet device 1, and supplies the received pen position information and pen speed information of the pen 30 to the MCU 36.

The DAC 32 converts digital data of a waveform signal, which includes a first frequency component as a sound signal for generating sound and a second frequency component as a vibration signal for generating vibration, into an analog waveform signal and outputs the analog waveform signal to the amplifier 33 on a subsequent stage. For example, the sampling rate of the DAC 32 is controlled by the MCU 36. The details of the waveform signal are described later.

The amplifier 33 amplifies the analog waveform signal output from the DAC 32 and outputs the amplified analog waveform signal to the actuator 34. The gain (amplification rate) of the amplifier 33 is controlled by the MCU 36.

The actuator 34 is an example of a vibration generator that generates vibrations based on the waveform signal. For example, the actuator 34 is a linear resonant actuator (LRA), which generates perceptible vibrations when driven at its resonant frequency. When the waveform signal is input to the actuator 34 via the amplifier 33 from the DAC 32, the actuator 34 is driven by the frequency component (the frequency component serving as a vibration signal to generate vibrations) of the resonance frequency contained in the waveform signal, thereby generating vibrations.

Additionally, when the actuator 34 is driven by a frequency component (the frequency component serving as a sound signal for generating sound) different from the resonant frequency contained in the waveform signal, the vibration level decreases due to being away from the resonant frequency, but the actuator 34 generates sound (sound waves).

In other words, the actuator 34 is driven with the waveform signal that includes both the frequency component of the vibration signal and the frequency component of the sound signal, thereby enabling generation of vibration to provide the user with a tactile sensation and generation of sound to allow the user to perceive writing sound.

Additionally, depending on the situation, either one or both of the frequency component of the vibration signal and the frequency component of the sound signal may be included in the waveform signal, thereby enabling selective generation of vibration only, sound only, or both vibration and sound.

The memory 35 is configured, for example, using a RAM or the like, and stores part of the control program for the pen 30 and processing data for the MCU 36. For example, the memory 35 stores digital data of the base waveform signal for driving the actuator 34 of the pen 30. Note that the memory 35 may include a flash memory or a ROM in addition to the RAM.

The MCU 36 includes a CPU, memories such as a ROM and a RAM, I/O-related components and the like, and comprehensively controls the pen 30. The MCU 36 causes the memory 35 to store the pen position information and pen speed information of the pen 30 received by the wireless communication unit 31. Additionally, the MCU 36 reads out digital data of the waveform signals from the memory 35 and supplies the digital data to the DAC 32. The MCU 36 then controls the DAC 32 and the amplifier 33 to supply the waveform signals to the actuator 34, thereby causing the actuator 34 to generate vibrations or sounds based on the waveform signals.

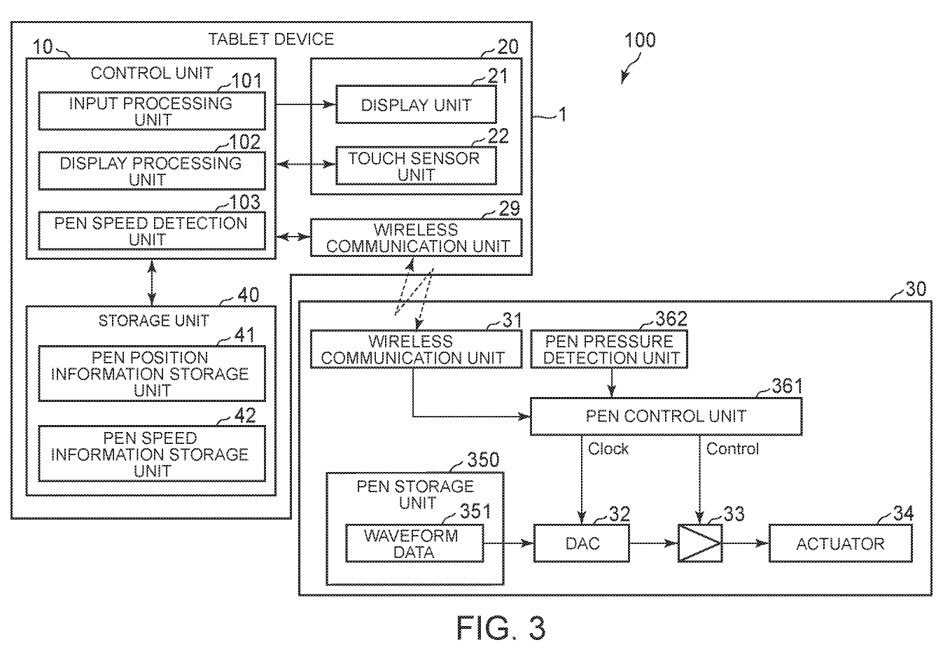

The following describes the functional configuration of the information processing system 100 according to one or more embodiments with reference to FIG. 3.

FIG. 3 is a block diagram illustrating an example of the functional configuration of the information processing system 100 according to one or more embodiments. In this FIG. 3, the same reference numerals are used for components corresponding to the respective parts in FIG. 2.

As illustrated in FIG. 3, the information processing system 100 includes the tablet device 1 and the pen 30. The tablet device 1 includes a control unit 10, a touch screen 20, a storage unit 40, and a wireless communication unit 29.

The touch screen 20 includes a display unit 21 and a touch sensor unit 22.

The touch sensor unit 22 detects the contact position of the pen 30 on the screen of the display unit 21 as pen input. The touch sensor unit 22 detects pen position information indicating, for example, the two-dimensional coordinates on the display screen DF of the display unit 21, as the contact position of the pen 30. The touch sensor unit 22 outputs the pen position information to the control unit 10.

The storage unit 40 is implemented, for example, by the main memory 12 or the flash memory 13, and includes a pen position information storage unit 41 and a pen speed information storage unit 42.

The pen position information storage unit 41 is implemented, for example, by the main memory 12, and stores the pen position information detected by the touch sensor unit 22 as pen position information. The pen position information storage unit 41 stores, for example, time information and pen position information in association with each other. The pen position information stored in the pen position information storage unit 41 is used, for example, when displaying the movement trajectory of the pen 30 on the screen onto the display unit 21 or when generating pen speed information.

The pen speed information storage unit 42 is implemented, for example, by the main memory 12, and stores pen speed information calculated based on the pen position information detected by the touch sensor unit 22.

The control unit 10 is a functional unit implemented by the processor 11 executing a program stored in the main memory 12 or the flash memory 13, and performs various processes based on the OS (for example, Android [registered trademark]). The control unit 10 includes an input processing unit 101, a display processing unit 102, and a pen speed detection unit 103.

The input processing unit 101 is, for example, a device driver that controls input from the touch sensor unit 22, and detects the contact and the contact position of the pen 30 on the screen (display screen DF) of the display unit 21, on the basis of an input to the touch sensor unit 22. The input processing unit 101 outputs the detected pen position information (position coordinates) of the pen 30 or the like to the OS. The pen position information detected by the input processing unit 101 is, for example, stored in the pen position information storage unit 41 by the OS in association with time information.

The display processing unit 102 performs processing related to the display of the display unit 21. For example, the display processing unit 102 displays the movement trajectory on the screen, which is generated by the pen 30 that comes into contact with the screen and moves, onto the display unit 21, on the basis of the contact position of the pen 30 detected by the touch sensor unit 22. In other words, the display processing unit 102 displays the movement trajectory of the pen 30 onto the display unit 21, on the basis of the pen position information of the pen 30 detected through the input processing unit 101. The display processing unit 102 generates the movement trajectory of the pen 30, for example, on the basis of the pen position information stored in the pen position information storage unit 41, and displays the movement trajectory on the display unit 21.

The pen speed detection unit 103 detects the movement speed of the pen 30 in real time, based on the pen position information detected by the touch sensor unit 22. For example, the pen speed detection unit 103 detects the movement speed of the pen 30 by calculating the movement speed from the movement amount per unit time of the contact position of the pen 30 on the basis of the pen position information detected by the touch sensor unit 22. The pen speed detection unit 103 generates pen speed information indicating the detected movement speed of the pen 30. The pen speed detection unit 103 transmits the pen speed information in real time to the pen 30 via the wireless communication unit 29 and stores the pen speed information in the pen speed information storage unit 42.

Note that the pen speed detection unit 103 may be implemented by an application program executed on the OS, or by a resident program that is resident on the OS. Additionally, the pen speed detection unit 103 may be provided in the pen 30 and may calculate the movement speed of the pen 30 by acquiring pen position information from the tablet device 1 via the wireless communication unit 29 to generate pen speed information.

The pen 30 includes a wireless communication unit 31, a DAC 32, an amplifier 33, an actuator 34, a pen storage unit 350, a pen control unit 361, and a pen pressure detection unit 362.

The pen storage unit 350 is a storage unit implemented, for example, by the memory 35 or the like, and stores various information used by the pen 30. The pen storage unit 350 stores waveform data 351 as digital data (basic waveform data) for a waveform signal that serves as a base for driving the actuator 34. The waveform data 351 is read out under the control of the pen control unit 361, converted into an analog waveform signal by the DAC 32, amplified by the amplifier 33, and supplied to the actuator 34.

The pen control unit 361 and the pen pressure detection unit 362 are functional units implemented, for example, by the MCU 36. The pen pressure detection unit 362 detects the contact pressure at the tip of the pen 30 using an unillustrated sensor, generates pen pressure information indicating the contact pressure, and outputs the pen pressure information to the pen control unit 361.

The pen control unit 361 comprehensively controls the pen 30. For example, the pen control unit 361 reads the waveform data 351 from the pen storage unit 350, based on the pen pressure information output from the pen pressure detection unit 362 and pen speed information received from the tablet device 1 via the wireless communication unit 31 or the like, and then supplies waveform signals to the actuator 34 via the DAC 32 and the amplifier 33. As a result, the pen control unit 361 drives the actuator 34, based on the waveform signals, to generate vibration and sound.

In this respect, the pen control unit 361, for example, changes the volume of the sound generated by the actuator 34 on the basis of the pen pressure information and pen speed information. When changing the volume, the pen control unit 361 uses a control signal (Control) to modify the amplification degree (amplification rate) of the amplifier 33.

Additionally, the pen control unit 361, for example, changes the pitch (the highness or lowness of a tone) of the sound generated by the actuator 34, based on the pen speed information. When changing the pitch of the sound, the pen control unit 361 uses a clock signal (Clock) to change the sampling rate of the DAC 32. In other words, the pen control unit 361 changes the pitch by modulating the frequency of the waveform signal (sound signal).

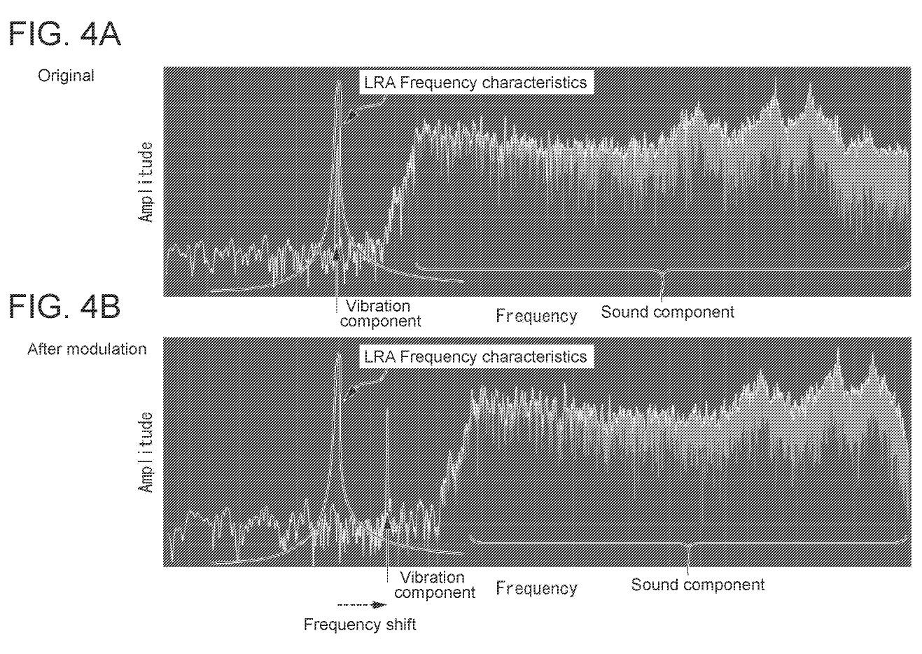

In this respect, changing the sampling rate to modulate the frequency of the waveform signal shifts the frequency of the entire waveform signal, including not only the sound signal but also the vibration signal. Therefore, with the conventional waveform signal, there has been a problem that the vibration level decreases even though only the pitch of the sound is intended to be changed. The problem of the conventional waveform signal is described below with reference to FIG. 4.

FIGS. 4A-4B are diagrams illustrating an example of the frequency characteristics of a conventional waveform signal. This diagram illustrates an example of the changes that occur when the sampling rate is changed using the DAC 32 for a conventional waveform signal that includes a frequency component (sound component) as a sound signal and a frequency component (vibration component) as a vibration signal. FIG. 4A illustrates the frequency characteristics of the original conventional waveform signal (original) without changing the sampling rate using the DAC 32, and FIG. 4B illustrates the frequency characteristics of the conventional waveform signal after changing the sampling rate using the DAC 32 (after modulation).

As illustrated in FIG. 4A, the vibration component contained in the conventional original waveform signal is set to a narrow bandwidth (narrow bandwidth matched to the resonant frequency) according to the frequency characteristics of the actuator 34 (LRA). Therefore, when the sampling rate is changed to alter the pitch of the sound, as illustrated in FIG. 4B, the overall frequency of the waveform signal shifts, thereby causing a problem that the vibration component deviates from the peak (resonant frequency) of the frequency characteristics of the actuator 34 (LRA), which in turn affects the level of vibration generated by the actuator 34. For example, the level of the vibration generated by the actuator 34 may decrease or the vibration may even cease entirely.

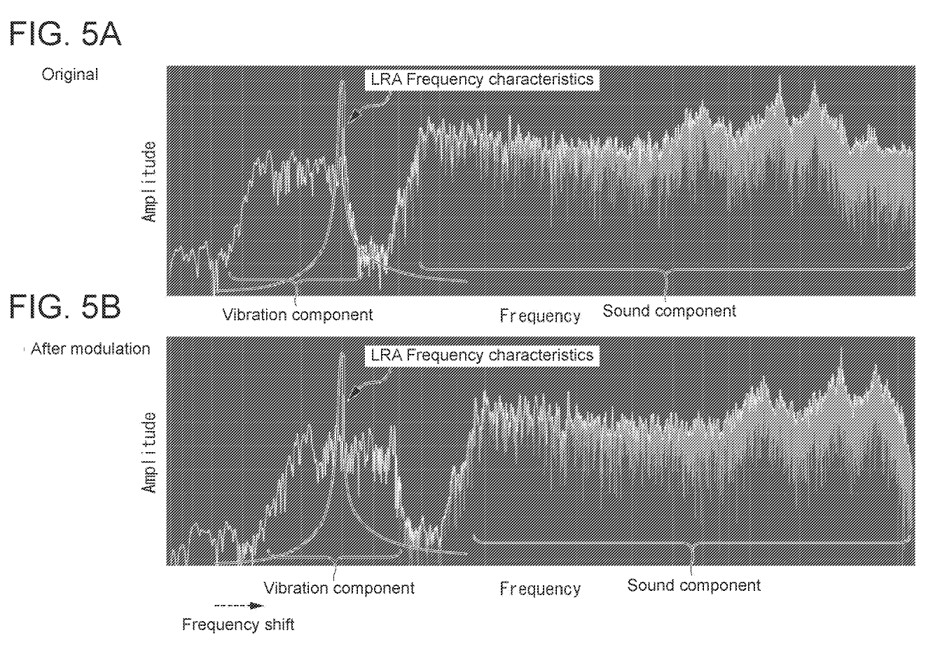

The following describes the waveform signal of the one or more embodiments, with reference to FIG. 5.

FIG. 5 is a diagram illustrating an example of the frequency characteristics of the waveform signal according to one or more embodiments. FIG. 5(A) illustrates the frequency characteristics of the waveform signal (original) of one or more embodiments without changing the sampling rate of the DAC 32, and FIG. 5(B) illustrates the frequency characteristics of the waveform signal of one or more embodiments after changing the sampling rate of the DAC 32 (after modulation).

As illustrated in FIG. 5, the vibration component of the waveform signal of one or more embodiments is set to have a wider bandwidth than the vibration component of the conventional waveform signal illustrated in FIG. 4. For example, the vibration component of the waveform signal of one or more embodiments is set to have a bandwidth (frequency range) corresponding to the change in the frequency of the waveform signal when the sampling rate is changed relative to the resonant frequency of the actuator 34 (LRA). The range of sampling rate changes corresponds to the predefined range for changing the pitch of the sound. The bandwidth (frequency range) corresponding to the change in the frequency of the waveform signal may have a constant margin relative to the range of sampling rate changes.

As a result, when using the waveform signal of one or more embodiments, even if the sampling rate is changed to change the pitch of the sound and the overall frequency of the waveform signal shifts, as illustrated in FIG. 5(B), vibration components are present at the peak (resonant frequency) of the frequency characteristics of the actuator 34 (LRA), and the vibration level generated by the actuator 34 is able to be maintained.

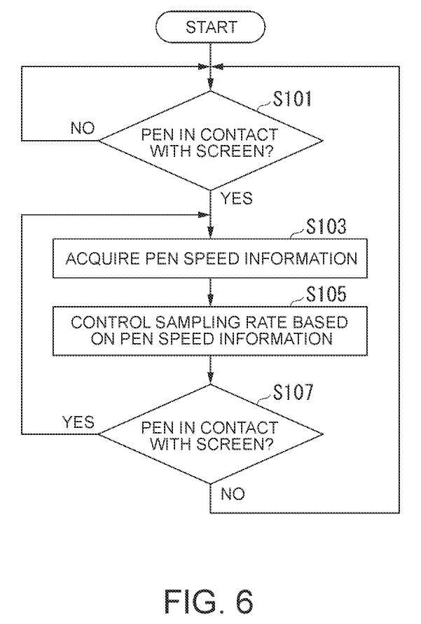

The following describes the actions of the information processing system 100 according to one or more embodiments with reference to appended drawings. In this specification, there are described the actions of the pitch change processing for changing the pitch of the sound generated by the pen 30 in accordance with the pen speed, with reference to FIG. 6.

FIG. 6 is a flowchart illustrating an example of pitch change processing of sound generated by the pen 30 in the information processing system 100 according to one or more embodiments.

(Step S101) The tablet device 1 determines whether the pen 30 is in contact with the screen (display screen DF) of the display unit 21. For example, the control unit 10 of the tablet device 1 determines whether the pen 30 is in contact with the screen (display screen DF) on the basis of the detection of the contact of the pen 30 by the touch sensor unit 22. When determining that the pen 30 is not in contact with the screen (step S101: NO), the control unit 10 repeats the processing of step S101. When determining that the pen 30 is in contact with the screen (step S101: YES), the control unit 10 starts detecting the movement speed of the pen 30 and transmits the pen speed information in real time to the pen 30 via the wireless communication unit 29. Then, the processing proceeds to step S103.

(Step S103) The pen 30 acquires the pen speed information transmitted from the tablet device 1. For example, the pen control unit 361 of the pen 30 acquires the pen speed information via the wireless communication unit 31. Then, the processing proceeds to step S105.

(Step S105) The pen 30 controls the pitch of the sound according to the movement speed of the pen 30. For example, the pen control unit 361 of the pen 30 controls the sampling rate of the DAC 32, on the basis of the acquired pen speed information. For example, the pen control unit 361 controls the sampling rate to be higher when the movement speed of the pen 30 is faster and to be lower when the movement speed of the pen 30 is slower, on the basis of the acquired pen speed information. As a result, the pitch of the sound generated by the actuator 34 of the pen 30 becomes higher as the movement speed of the pen 30 increases and lower as the movement speed of the pen 30 decreases. Then, the processing proceeds to step S107.

(Step S107) The tablet device 1 determines whether the pen 30 is still in contact with the screen (display screen DF) of the display unit 21. For example, the control unit 10 of the tablet device 1 determines whether the pen 30 is in contact with the screen (display screen DF) on the basis of the detection of the contact of the pen 30 by the touch sensor unit 22. When determining that the pen 30 is in contact with the screen (step S107: YES), the control unit 10 returns to the processing of step S103, continues to acquire pen speed information, and controls the pitch of the sound according to the movement speed of the pen 30. Additionally, when determining that the pen 30 is not in contact with the screen (step S107: NO), the control unit 10 terminates the detection of the movement speed of the pen 30 and returns to the processing of step S101. The pen 30 stops the generation of the sound from the actuator 34.

As described above, the information processing system 100 according to one or more embodiments includes the tablet device 1 (an example of an information processing apparatus) and the pen 30 capable of communicating with the tablet device 1. The pen 30 includes the actuator 34 (an example of a vibration generator) that vibrates based on a waveform signal, the DAC 32 (an example of an output unit), and the pen control unit 361 (an example of a control unit). The DAC 32 samples a waveform signal containing a first frequency component (sound component) as a sound signal and a second frequency component (vibration component) as a vibration signal, and outputs the waveform signal to the actuator 34. The pen control unit 361 changes the sampling rate used when sampling according to the movement speed of the pen 30, which moves in contact with the screen (an example of an operation symmetrical surface) of the display unit 21. Furthermore, the frequency component (vibration component) as a vibration signal is set to have a bandwidth equal to the amount by which the frequency of the waveform signal shifts (changes) when the sampling rate of the DAC 32 is changed in response to a frequency (for example, a resonant frequency) preset for the actuator 34.

Thereby, the information processing system 100 is able to change the pitch (the highness or lowness of a tone) of the sound generated from the pen 30 according to the movement speed of the pen 30 so as not to affect the level of vibration generated from the pen 30. Therefore, the information processing system 100 is able to convey nuances of handwritten input by the pen 30 more effectively.

For example, the actuator 34 is a linear resonant actuator, and the frequency preset for the actuator 34 is the resonant frequency of the actuator 34.

This allows the information processing system 100 to change the pitch (the highness or lowness of a tone) of the sound generated from the pen 30 according to the movement speed of the pen 30 so as not to affect the vibration level of the actuator 34, which generates vibrations at the resonant frequency thereof.

Furthermore, in the waveform signal, the frequency component (sound component) as a sound signal is set to a bandwidth different from the bandwidth of the frequency component (vibration component) as a vibration signal. The actuator 34 generates sound on the basis of the frequency component (sound component) as the sound signal included in the waveform signal output from the DAC 32, and the pitch of the generated sound changes in response to changes in the sampling rate of the DAC 32.

As a result, the information processing system 100 is able to generate not only vibration but also sound from the pen 30 by driving the actuator 34 using a waveform signal containing different bandwidths of the sound component and the vibration component, thereby eliminating the need for an internal speaker, thus reducing costs.

Additionally, the tablet device 1 includes a pen speed detection unit 103 (an example of a speed detection unit) that detects the movement speed of the pen 30 that moves in contact with the screen (an example of an operation symmetrical surface) of the display unit 21, and a wireless communication unit 29 (an example of a transmission unit) that transmits information about the movement speed of the pen 30 (pen speed information) detected by the pen speed detection unit 103 to the pen 30. Additionally, the pen 30 includes a wireless communication unit 31 (an example of a receiving unit) that receives information about the movement speed of the pen 30 (pen speed information) transmitted from the tablet device 1. Furthermore, the pen control unit 361 changes the sampling rate for sampling by the DAC 32 in accordance with the movement speed of the pen 30, on the basis of the information about the movement speed of the pen 30 (the pen speed information) received by the wireless communication unit 31.

As a result, the information processing system 100 detects the movement speed of the pen 30 using the tablet device 1 when handwritten input is made by the pen 30 on the screen of the display unit 21 of the tablet device 1 and transmits the movement speed to the pen 30, thereby enabling the pitch (the highness or lowness of a tone) of the sound generated from the pen 30 to be varied according to the movement speed of the pen 30.

Additionally, the pen 30 includes the amplifier 33 (an example of amplifiers) that amplifies the waveform signal output from the DAC 32 and outputs the amplified waveform signal to the actuator 34. The pen control unit 361 controls the amplification rate of the amplifier 33 in accordance with the movement speed of the pen 30.

Thereby, the information processing system 100 is able to change the volume of the sound generated from the pen 30 in accordance with the movement speed of the pen 30. Thus, the information processing system 100 is able to convey nuances of handwritten input by the pen 30 more effectively.

Furthermore, the tablet device 1 includes the display unit 21 as an operation symmetrical surface.

This allows the information processing system 100 to cause the pen 30 to generate vibration and sound when handwritten input is made by the pen 30 on the screen of the display unit 21 of the tablet device 1, and also to vary the pitch (the highness or lowness of a tone) of the sound generated from the pen 30 in accordance with the movement speed of the pen 30, so as not to affect the vibration level.

Furthermore, the control method of the information processing system 100 according to one or more embodiments, which includes a tablet device 1 (an example of an information processing apparatus) and a pen 30 that is capable of communicating with the tablet device 1 and has an actuator 34 (an example of a vibration generator) that vibrates based on a waveform signal, includes the steps of: sampling a waveform signal containing a frequency component (sound component) as a sound signal and a frequency component (vibration component) as a vibration signal and outputting the waveform signal to the actuator 34; and changing the sampling rate used when sampling in accordance with the movement speed of the pen 30 moving in contact with the screen (an example of an operation symmetrical surface) of the display unit 21. Furthermore, the frequency component (vibration component) as a vibration signal is set to have a bandwidth equal to the amount by which the frequency of the waveform signal shifts (changes) when the sampling rate of the DAC 32 is changed relative to a frequency (for example, a resonant frequency) preset for the actuator 34.

This allows the control method for the information processing system 100 to change the pitch (the highness or lowness of a tone) of the sound generated from the pen 30 in response to the movement speed of the pen 30 so as not to affect the level of vibration generated from the pen 30. Therefore, the control method in the information processing system 100 is able to convey nuances of handwritten input by the pen 30 more effectively.

The present invention is not limited to the above embodiment and may be modified without departing from the scope of the present invention.

For example, in the above embodiments, the information processing apparatus is described as a tablet device 1, but the present invention is not limited thereto. The information processing apparatus may be, for example, a laptop personal computer equipped with a smartphone or tablet mode.

Furthermore, in the above embodiments, an example of an OS to be used is Android (registered trademark), but the present invention is not limited thereto, and may be applied to other OSs such as, for example, iOS (registered trademark).

Furthermore, in the above embodiments, an example of the vibration generator has been described using the actuator 34, which is a linear resonant actuator, but the present invention is not limited thereto, and other devices may also be used as long as being vibration generators able to be driven by a waveform signal, for example.

Furthermore, in the above embodiments, an example that the wireless communication unit 29 and the wireless communication unit 31 use Bluetooth (registered trademark) as the wireless communication method has been described, but the present invention is not limited thereto, and other wireless communication methods may be used. Additionally, the communication between the tablet device 1 and the pen 30 may be wired communication, instead of wireless communication.

In the above embodiments, an example was given for describing that the pen 30 is equipped with a pen pressure detection unit 362 that detects the contact pressure of the tip of the pen 30. The present invention, however, is not limited thereto, and the pen 30 need not be equipped with a sensor for detecting contact pressure, and the tablet device

1 may detect the contact pressure of the tip of the pen 30. For example, in the case where the touch sensor unit 22 is a capacitive touch sensor, the tablet device 1 may detect the contact pressure on the basis of the capacitance value detected by the touch sensor unit 22 at the contact position of the pen 30, and may transmit pen pressure information indicating the contact pressure to the pen 30. Additionally, the tablet device 1 may transmit the capacitance value detected by the touch sensor unit 22 at the contact position of the pen 30 to the pen 30, thereby allowing the pen 30 to detect the capacitance value as the pen pressure information.

Furthermore, in the above embodiments, the configuration that the pen 30 does not have a built-in speaker and the actuator 34 is able to generate vibration and sound has been described, but the pen 30 may additionally have a built-in speaker.

Additionally, each component of the information processing system 100 described above includes a computer system internally. Furthermore, programs for implementing the functions of the respective components of the information processing system 100 described above may be recorded on a computer-readable recording medium, and the programs recorded on the recording medium may be loaded into the computer system and executed to perform the processes of the components of the information processing system 100 described above. In this respect, "loading the programs recorded on the recording medium into the computer system and executing the programs" includes installing the programs into the computer system. The term "computer system" as used herein includes hardware such as an operating system (OS) and peripheral equipment.

Additionally, the term "computer system" may include multiple computer devices connected via a network including communication lines such as the Internet, WAN, LAN, or dedicated lines. Furthermore, the term "computer-readable recording medium" means a portable medium such as a flexible disk, an optical magnetic disk, a ROM, or a CD-ROM, or a storage device such as a hard disk or the like built in a computer system. Thus, the recording medium storing the programs may be a non-transitory recording medium such as a CD-ROM.

Furthermore, the recording medium includes a recording medium located internally or externally that is accessible from a distribution server for distributing the programs. Additionally, the program may be divided into multiple parts, downloaded at different times, and then combined in each component of the information processing system 100, or the distribution servers for the respective divided programs may be different from each other. Furthermore, the term "computer-readable recording medium" includes a recording medium that retains a program for a certain period of time, such as a volatile memory (RAN) within a computer system that acts as a server or a client when the program is transmitted via a network. Additionally, the aforementioned program may be intended to implement only a part of the above functions. Furthermore, the aforementioned program may be a so-called difference file (difference program) that is able to implement the above functions in combination with programs already recorded in a computer system.

Additionally, some or all of the functions described above may be implemented as an integrated circuit such as a large scale integration (LSI). Each of the functions described above may be implemented as individual processors, or some or all of the functions may be integrated and implemented as a processor. Furthermore, the method of integrating circuits may not be limited to LSI, but may also be implemented using a dedicated circuit or a general-purpose processor. Furthermore, in the case where a new integrated circuit technology emerges that can replace LSI due to advancements in semiconductor technology, an integrated circuit generated by the new technology may also be employed.

### DESCRIPTION OF SYMBOLS

1 tablet device

10 control unit

11 processor

12 main memory

13 flash memory

20 touch screen

21 display unit

22 touch sensor unit

23 peripheral devices

24 audio system

25 microphone

26 speaker

27 baseband chip

28 wireless unit

29, 31 wireless communication unit

30 pen

DAC

amplifier

actuator

memory

MCU

storage unit

pen position information storage unit

pen speed information storage unit

information processing system

input processing unit

display processing unit

pen speed detection unit

pen storage unit

pen control unit

pen pressure detection unit

What is claimed is:

1. An information processing system comprising:
an information processing apparatus; and
a pen configured to communicate with the information processing apparatus,
wherein the pen includes:a vibration generator that vibrates based on a waveform signal;an output unit that samples the waveform signal containing a first frequency component as a sound signal and a second frequency component as a vibration signal and outputs the waveform signal to the vibration generator; anda control unit that, when sampling the waveform signal, changes a sampling rate of the waveform signal in accordance with a movement speed of the pen that moves in contact with an operation symmetrical surface;
wherein the second frequency component as the vibration signal is set to have a bandwidth corresponding to a change in the frequency of the waveform signal when the sampling rate is changed relative to a preset frequency of the vibration generator.

2. The information processing system according to claim 1
wherein the vibration generator is a linear resonant actuator; and
the preset frequency of the vibration generator is a resonant frequency of the vibration generator.

3. The information processing system according to claim 1, wherein:
in the waveform signal, the first frequency component as the sound signal is set to a bandwidth different from the bandwidth of the second frequency component as the vibration signal;
the vibration generator generates sound based on the first frequency component as the sound signal contained in the waveform signal output from the output unit; and
a pitch of the generated sound changes in accordance with changes in the sampling rate.

4. The information processing system according to claim 1
wherein the information processing apparatus includes:a speed detection unit that detects the movement speed of the pen that moves in contact with the operation symmetrical surface; anda transmission unit that transmits information about the movement speed of the pen detected by the speed
detection unit to the pen,wherein the pen includes a receiving unit that receives information about the movement speed of the pen transmitted from the information processing apparatus, andwherein the control unit changes the sampling rate used for performing the sampling in accordance with the movement speed of the pen, based on the information about the movement speed of the pen received by the receiving unit.

5. The information processing system according to claim 1, wherein:
the pen includes an amplifier that amplifies the waveform signal output from the output unit and outputs the waveform signal to the vibration generator; and
the control unit controls an amplification rate of the amplifier according to the movement speed of the pen.

6. The information processing system according to claim 1, wherein the information processing apparatus includes a display unit as the operation symmetrical surface.

7. A control method for an information processing system that includes an information processing apparatus and a pen configured to communicate with the information processing apparatus and having a vibration generator that
vibrates based on a waveform signal, the method comprising the steps of:sampling the waveform signal containing a first frequency component as a sound signal and a second frequency component as a vibration signal and outputting the waveform signal to the vibration generator, with the pen; andwherein sampling the waveform signal comprises changing a sampling rate of the waveform signal in accordance with a movement speed of the pen that moves in contact with an operation symmetrical surface, with the pen,wherein the second frequency component as the vibration signal is set to have a bandwidth corresponding to a change in the frequency of the waveform signal when the sampling rate is changed relative to a preset frequency of the vibration generator.
